(19) United States
(12) Patent Application Publication
(10) Pub. No.: US 2026/0099060 A1
(43) Pub. Date: Apr. 9, 2026

(54) AIR FLOATING VIDEO DISPLAY APPARATUS

(71) Applicant: Maxell, Ltd., Kyoto (JP)

(72) Inventors: Sho ASAKURA, Kyoto (JP); Toshimitsu WATANABE, Kyoto (JP); Takuya SHIMIZU, Kyoto (JP); Kazuhiko TANAKA, Kyoto (JP); Mitsuyoshi FURUHATA, Kyoto (JP)

(21) Appl. No.: 19/114,884

(22) PCT Filed: Aug. 30, 2023
(86) PCT No.: PCT/JP2023/031416

§ 371 Date: Mar. 25, 2025

(30) Foreign Application Priority Data
Sep. 26, 2022 (JP) 2022-152333

(51) Int. Cl. G02B 30/56; G02B 5/124; H04N 13/122

(52) U.S. Cl. CPC G02B 30/56; G02B 5/124; H04N 13/122

(57) ABSTRACT

The air floating video display apparatus includes: a video input I/F; a video processing circuit processing a video, based on an input video to be input via the video input I/F; a video display displaying the processed video; and a retroreflector reflecting video light emitted from the video display to form the air floating video. An optical path length of the video light emitted from a display surface of the video display, starting from when the video light is emitted from the display surface and then is reflected on the retroreflector to when the video light reaches a position of the air floating video, differs depending on a position on the display surface from which the video light is emitted, and the video processing circuit performs a different video sharpness/detail processing to a plurality of positions of a video based on the input video.

### TECHNICAL FIELD

The present invention relates to an air floating video display apparatus.

### BACKGROUND ART

For example, as disclosed in a Patent Document 1, an air floating information display technique is achieved by an imaging method using retroreflection.

### RELATED ART DOCUMENT

### Patent Document

Patent Document 1: Japanese Patent Application No. 2018-564127

### SUMMARY OF THE INVENTION

### Problems to be Solved by the Invention

However, in the disclosure of the Patent Document 1, the optical path length to the imaging surface of the video differs depending on each region, and therefore, the resolution of the air floating video differs.

When the resolution differs depending on each region of the video, the sharpness/detail differs depending on the display position, and this results in that creation of a size of a character in a content or the like is limited so as to be visually recognizable in a region with the lowest sharpness/detail, or results in that accuracy of input operations for the air floating video differs depending on each region or the like, and therefore, a user may strongly feel discomfortable.

The present invention has been made in consideration of these circumstances, and an objective of the present invention is to provide a more suitable air floating video display apparatus.

### Means for Solving the Problems

In order to solve the above problems, according to one embodiment of the present invention, for example, it is sufficient to configure an air floating video display apparatus for displaying an air floating video so as to include: a video input interface; a video processing circuit processing a video, based on an input video to be input via the video input interface; a video display displaying a video processed by the video processing circuit; and a retroreflector reflecting video light emitted from the video display to form the air floating video. In the air floating video display apparatus, an optical path length of the video light emitted from a display surface of the video display, starting from when the video light is emitted from the display surface of the video display and then is reflected on the retroreflector to when the video light reaches a position of the air floating video, differs depending on a position on the display surface of the video display from which the video light is emitted, and the video processing circuit performs a different video sharpness/detail processing to a plurality of positions of a video based on the input video so as to correspond to a plurality of positions that are different in the optical path length of the video light.

### Effects of the Present Invention

According to the present invention, a more suitable air floating video display apparatus can be achieved.

### BRIEF DESCRIPTIONS OF THE DRAWINGS

FIG. 1 is a diagram showing an example of a use form of an air floating video display apparatus according to one embodiment of the present invention;

FIG. 2 is a diagram showing an example of a main part configuration and a retroreflector portion configuration of an air floating video display apparatus according to one embodiment of the present invention;

FIG. 3A is a projection view of a retroreflector constituting an air floating video display apparatus according to one embodiment of the present invention;

FIG. 3B is a top view of a retroreflector constituting an air floating video display apparatus according to one embodiment of the present invention;

FIG. 4A is a perspective view showing a corner reflector constituting a retroreflector constituting an air floating video display apparatus according to one embodiment of the present invention;

FIG. 4B is a top view showing a corner reflector constituting a retroreflector constituting an air floating video display apparatus according to one embodiment of the present invention;

FIG. 4C is a side view showing a corner reflector constituting a retroreflector constituting an air floating video display apparatus according to one embodiment of the present invention;

FIG. 5 is a circuit block diagram controlling an air floating video display apparatus according to one embodiment of the present invention;

FIG. 6A is a diagram showing an imaging optical path in a configuration example of an air floating video display apparatus according to one embodiment of the present invention;

FIG. 6B is a diagram showing an imaging optical path in a configuration example of an air floating video display apparatus according to one embodiment of the present invention;

FIG. 7A is a diagram showing an example of an output air floating video of an air floating video display apparatus according to one embodiment of the present invention;

FIG. 7B is a diagram showing luminance distribution of an output air floating video of an air floating video display apparatus according to one embodiment of the present invention;

FIG. 8 is a diagram showing optical transmission characteristics of an air floating video display apparatus with respect to a spatial frequency according to one embodiment of the present invention;

FIG. 9 is a diagram showing an example of an image processing method according to one embodiment of the present invention;

FIG. 10A is a diagram showing components of various filters used in an image processing method according to one embodiment of the present invention;

FIG. 10B is a diagram showing components of various filters used in an image processing method according to one embodiment of the present invention;

FIG. 11 is a diagram showing evaluation indexes in waveform changes of a video signal obtained based on an image processing method according to one embodiment of the present invention;

FIG. 12A is a diagram showing an example of a filter setting of an image processing method according to one embodiment of the present invention;

FIG. 12B is a diagram showing an example of a filter setting of an image processing method according to one embodiment of the present invention;

FIG. 12C is a diagram showing waveform changes of a video signal obtained based on various filter parameters used in an image processing method according to one embodiment of the present invention;

FIG. 13A is a diagram showing an example of a filter setting of an image processing method according to one embodiment of the present invention;

FIG. 13B is a diagram showing an example of a filter setting of an image processing method according to one embodiment of the present invention;

FIG. 13C is a diagram showing waveform changes of a video signal obtained based on various filter parameters used in an image processing method according to one embodiment of the present invention;

FIG. 14A is a diagram showing an example of a filter setting of an image processing method according to one embodiment of the present invention; and

FIG. 14B is a diagram showing waveform changes of a video signal obtained based on various filter parameters used in an image processing method according to one embodiment of the present invention.

### DETAILED DESCRIPTION OF PREFERRED EMBODIMENTS

Hereinafter, embodiments of the present invention will be described in detail with reference to the accompanying drawings. Note that the present invention is not limited to the explanations for embodiments, and various modifications and alterations can be made within the scope of the technical ideas disclosed in the present specification by those who skilled in the art. Also, components having the same function are denoted by the same reference symbols throughout all the drawings for describing the present invention, and the repetitive description thereof will be omitted.

The following embodiments relate to a video display apparatus capable of transmitting a video formed by video light emitted from a video light source through a transparent member such as glass that partitions a space, and displaying the video as an air floating video outside the transparent member. In the following explanation for the embodiments, the floating video in air is expressed as a term “air floating video”. In place of this term, this may be expressed as “air image”, “aerial image”, “air floating video”, “air floating optical image of display video”, “air floating optical image of display video”, or others. The term “air floating video” mainly used in the explanation for the embodiments is used as a typical example of these terms.

According to the following embodiments, for example, a video display apparatus suitable for bank ATMs, station ticket vending machines, and digital signages, and the like can be achieved. For example, currently, touch panels are usually used in bank ATMs, ticket vending machines at stations, and the like, and high-resolution video information can be displayed above a transparent glass surface or light-transmittable plate material to be used while being aerially floated. Also, for example, a vehicular air floating video display apparatus can be provided, the vehicular air floating video display apparatus being capable of making the video visually recognizable inside and/or outside the vehicle, in other words, capable of aerially unidirectionally displaying the video. This video display apparatus can correct the sharpness/detail on the entire surface of the air floating video to the same degree by employing a suitable image processing method. This image processing method improves the accuracy of the input operations on the air floating video.

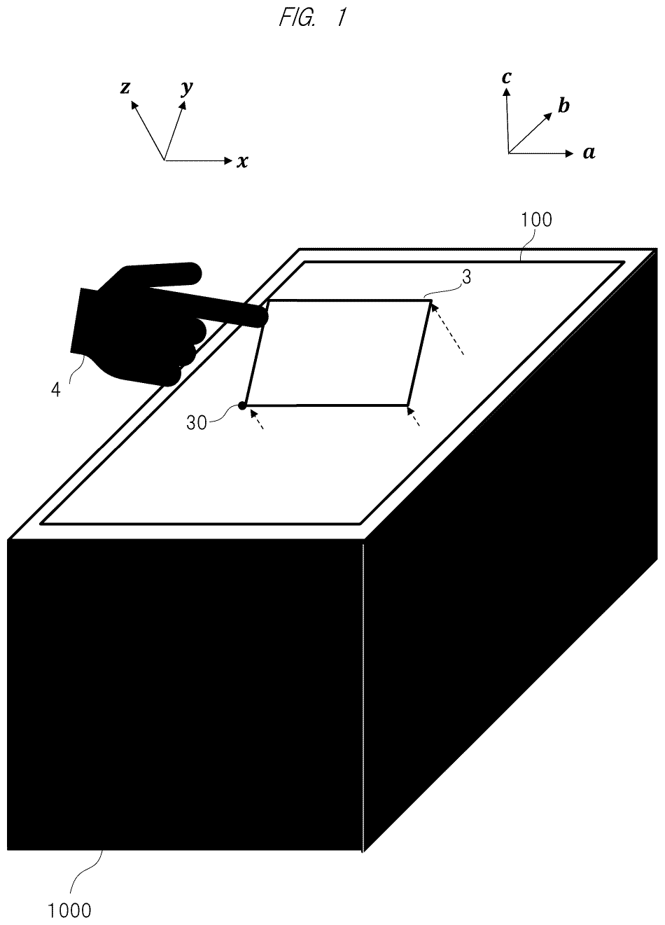

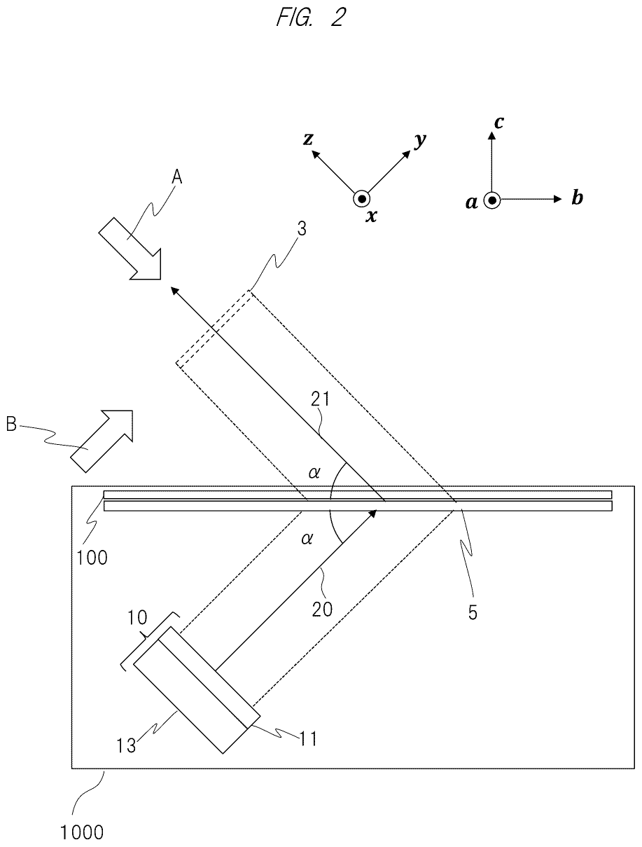

FIG. 1 is a diagram showing an example of a use form of an air floating video display apparatus according to one embodiment of the present invention, and is a diagram showing the overall configuration of the air floating video display apparatus according to the present embodiment. The specific configuration of the air floating video display apparatus will be described in detail with reference to FIG. 2 and the like. A focusing video light flux due to retroreflection is emitted from an air floating video display apparatus 1000, penetrates through a transparent material 100 (such as glass), and forms an aerial image (air floating video 3) which is a real image outside the glass surface. A response to an input operation 4 can be reflected on the air floating video 3. In the following embodiments, three axes that are a right direction as “x”-direction, a downward (upward) direction as “y”-direction, and a depth direction as “z”-direction with respect to an end point 30 of the imaging plane as the origin are set as a commonalized coordinate system in each configuration diagram. Similarly, three axes that are a width direction of the air floating video display apparatus 1000 as “a”-direction, a depth direction of the same as “b”-direction, and a height direction of the same as “c”-direction are set as a commonalized coordinate system in each composition diagram. The diagrams for explaining the air floating video display apparatus and the output air floating video may be illustrated with the xyz-direction axis or the abc-direction axis as the coordinate systems indicating the corresponding directions to each diagram.

FIG. 2 is a diagram showing an example of the main part configuration and the retroreflector portion configuration of an air floating video display apparatus according to one embodiment of the present invention. A display 10 that emits specific video light is provided in the oblique direction of the transparent member 100 such as glass. The display 10 includes a liquid crystal display panel 11 and a light source 13 that generates light having inherent diffusion property.

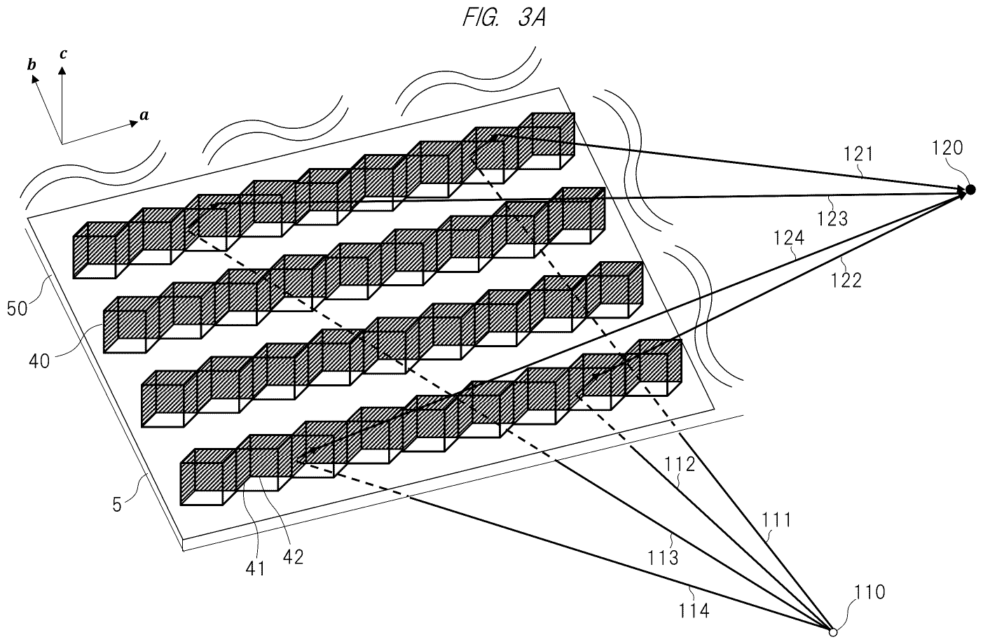

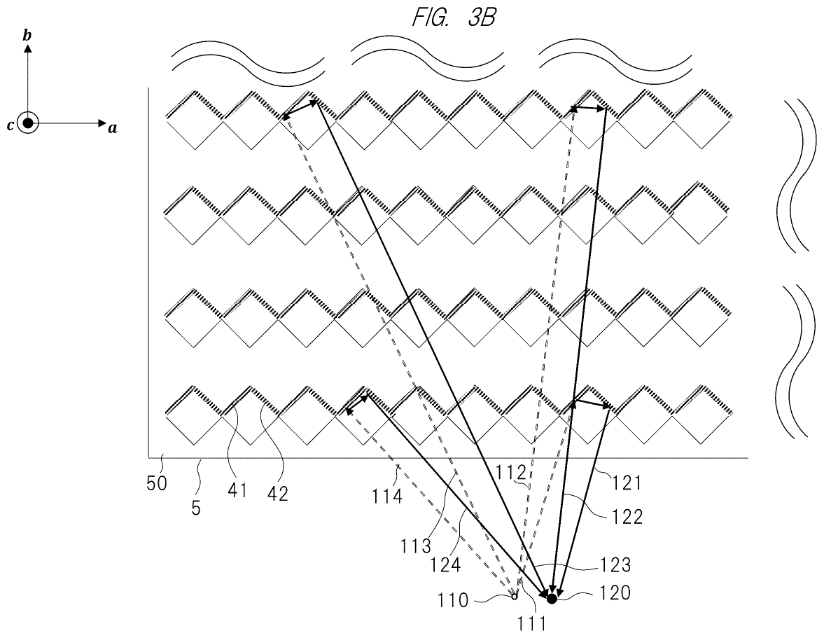

A principal light ray 20 that is a typical light flux emitted from the display 10 propagates in the y-direction, and enters a retroreflector 5 at an incident angle “α” (such as 45°). The retroreflector 5 is an optical member having an optical property that retroreflects light rays in at least a part of directions. Also, since the reflected light ray has an optical property forming an image, the retroreflector 5 may be described as an imaging optical member or an imaging optical plate. The specific configuration of the retroreflector 5 will be described in detail with reference to FIGS. 3A and 3B and the like. By the retroreflector 5, the principal light ray 20 is retroreflected in the a- and b-directions while being propagated in the c-direction. As a result, a reflected light ray 21 propagates in the z-direction, penetrates through the transparent member 100, and forms the air floating video 3 as the real image on the imaging surface.

A light flux that forms the air floating video 3 is aggregate of light rays converging from the retroreflector 5 to the optical image of the air floating video 3, and these light rays rectilinearly propagate even after penetrating through the optical image of the air floating video 3. Therefore, the air floating video 3 is a video having high directionality as different from the diverged (diffuse) video formed on a screen by a general projector or the like. Therefore, in the configuration of FIG. 2, when the user visually recognizes the air floating video 3 in a direction of an arrow A, the air floating video 3 is visually recognized as a bright video. However, when a different person visually recognizes the air floating video 3 in a direction of an arrow B, the air floating video 3 cannot be visually recognized as a video at all. Such a property is very suitable when being applied to a system displaying a video requiring high security, a video having high confidentiality that needs to be secured for a person facing the user or the like.

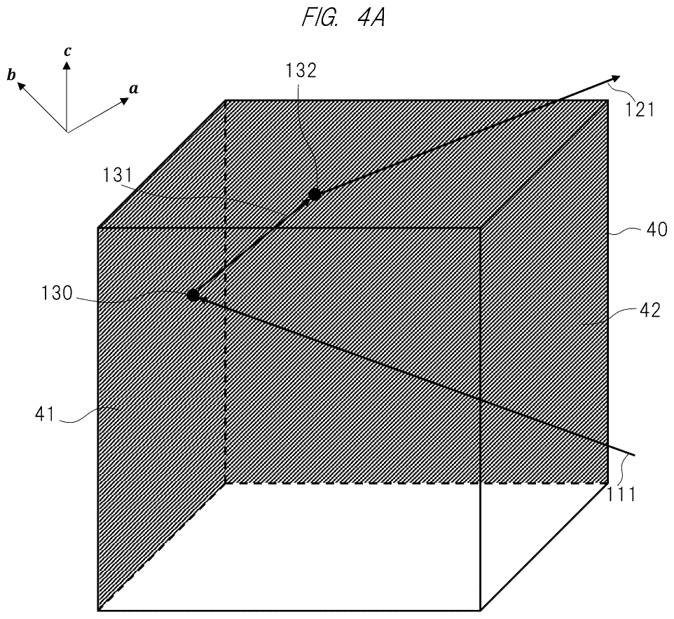

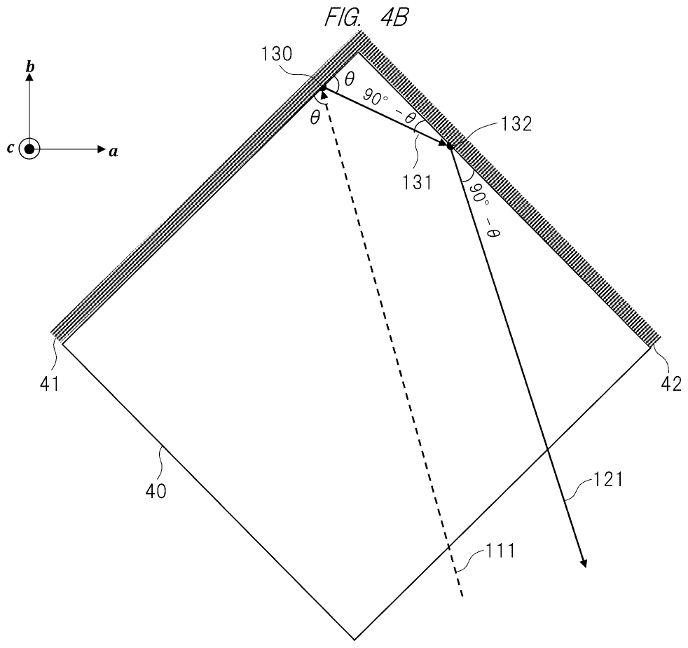

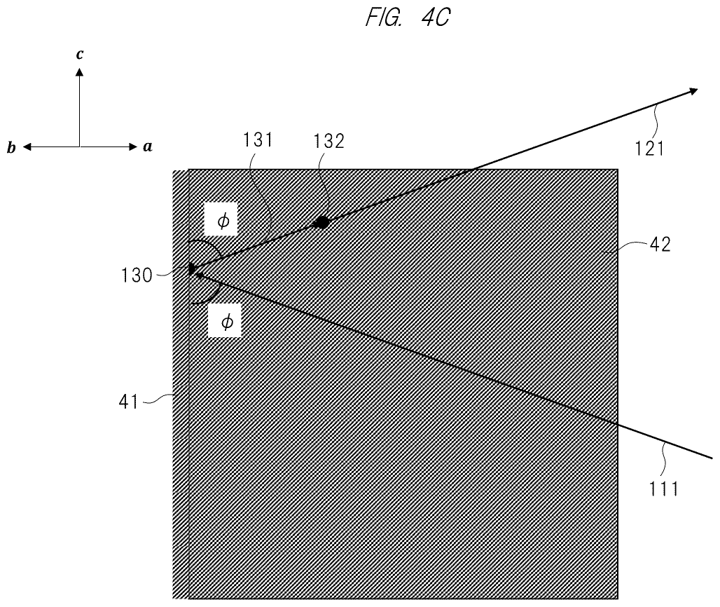

An example of the configuration of the retroreflector 5 will be described with reference to FIGS. 3A and 3B. The retroreflector 5 has a configuration in which a plurality of corner reflectors 40 are arranged in an array pattern on a surface of a transparent member 50. The specific configuration of the corner reflectors 40 will be described in detail with reference to FIGS. 4A, 4B and FIG. 4C. Light rays 111, 112, 113, and 114 emitted from the light source 110 are reflected twice by two mirror surfaces 41 and 42 of the corner reflector 40 to become reflected light rays 121, 122, 123, and 124. These two reflections for the a- and b-directions are retroreflections that turn the light back in the same direction as the incident direction (propagate in a direction rotated by 180°), but reflections for the c-direction are normal reflections where the incident angle and the reflection angle coincide with each other due to total reflection. That is, the light rays 111 to 114 generate the reflected light rays 121 to 124 on a straight line symmetrical in the c-direction with respect to the corner reflector 40, and form an air real image 120. Note that the light rays 111 to 114 emitted from the light source 110 are four light rays typifying diffuse light emitted from the light source 110. The light rays incident on the retroreflector 5 are not limited to these light rays, depending on the diffusion property of the light source 110, but any incident light ray causes the similar reflection, and forms the air real image 120. For ease of seeing the drawings, the position of the light source 110 and the position of the air real image 120 in the a-direction are illustrated while being different from each other. However, practically, the position of the light source 110 and the position of the air real image 120 in the a-direction are the same as each other, and are overlapped with each other when being viewed from the c-direction.

Next, the configuration and effect of the corner reflector 40 configuring the retroreflector 5 are described with reference to FIGS. 4A, 4B and 4C. The corner reflector 40 has a rectangular parallelepiped shape in which only two specific surfaces are mirror surfaces 41 and 42 but the other four surfaces are made of transparent members. The retroreflector 5 has a configuration in which the corresponding mirror surfaces of the corner reflectors 40 that are arranged in the array pattern face the same direction.

When being viewed from an upper surface (a “+c”-direction), the light ray 111 emitted from the light source 110 enters the mirror surface 41 (or the mirror surface 42) at a specific incident angle, and is totally reflected by a reflection point 130, and then, is totally reflected again by a reflection point 132 on the mirror surface 42 (or the mirror surface 41). If an incident angle of the light ray 111 on the mirror surface 41 (or the mirror surface 42) is assumed to be “θ”, an incident angle of a first reflected light ray 131 on the mirror surface 42 (or the mirror surface 41), the light ray being reflected by the mirror surface 41 (or the mirror surface 42), can be expressed as “90°-θ”. Therefore, a second reflected light ray 121 is rotated by “2θ” from the light ray 111 by the first reflection, and then, is rotated by “2×(90°-θ)” by the second reflection, and therefore, an inverted light path of 180° in total is formed. On the other hand, when being viewed from a side surface (a direction between “-a”- and “-b”-directions), the total reflection in the c-direction occurs only once. Therefore, if the incident angle on the mirror surface 41 or the mirror surface 42 is assumed to be “φ”, the reflected light ray 121 is rotated by “2×φ” from the light ray 111 by one reflection.

From the above description, the light rays incident on the corner reflector 40 are retroreflected to form the inverted light paths in the a- and b-directions, but are totally reflected by the total reflection in the c-direction. In consideration of the retroreflector 5, the same reflection is caused in each light path, and therefore, an image is formed at a symmetric point around the c-axis direction by the inverted light path having convergence for the a- and b-directions. The resolution of the air floating image formed by the light rays from the video output portion 10 significantly depends on not only the resolution of the liquid crystal display panel 11 but also a diameter “D” and a pitch “P” (not illustrated) of a retroreflection portion of the retroreflector 5 shown in FIGS. 3A and 3B. For example, when a WUXGA liquid crystal display panel 11 of 7 inches (1920×1200 pixels) is used, even if one pixel (one triplet) is about 80 μm, if the diameter D and the pitch P of the retroreflection portion are, for example, 240 μm and 300 μm, respectively, one pixel of the air floating video is equivalent to 300 μm. Therefore, effective resolution of the air floating video decreases down to about ⅓.

Accordingly, in order to make the resolution of the air floating video equal to the resolution of the video display 10, it is desirable to make the diameter D and the pitch P of the retroreflection portion close to one pixel of the liquid crystal display panel. Meanwhile, in order to suppress the moire based on the pixels of the liquid crystal display panel and the retroreflector, each pitch ratio may be designed to deviate from an integral multiple of one pixel.

Note that the shape of the retroreflector (imaging optical plate) according to the present embodiment is not limited to the above example. It may be various types of shapes that achieve the retroreflection. Specifically, it may be a variety of cubic corner bodies, a slit mirror array, or a shape in which the combinations of the reflective surfaces thereof are periodically arranged. Alternatively, the surface of the retroreflector of the present embodiment may be provided with a capsule lens-type retroreflective element in which glass beads are periodically arranged. A detailed description for the detailed configuration of these retroreflective elements will be omitted since the configuration is achieved by an existing technique. Specifically, techniques disclosed in Japanese Patent Application Laid-open Publications No. 2017-33005 and No. 2019-133110 and the like may be used.

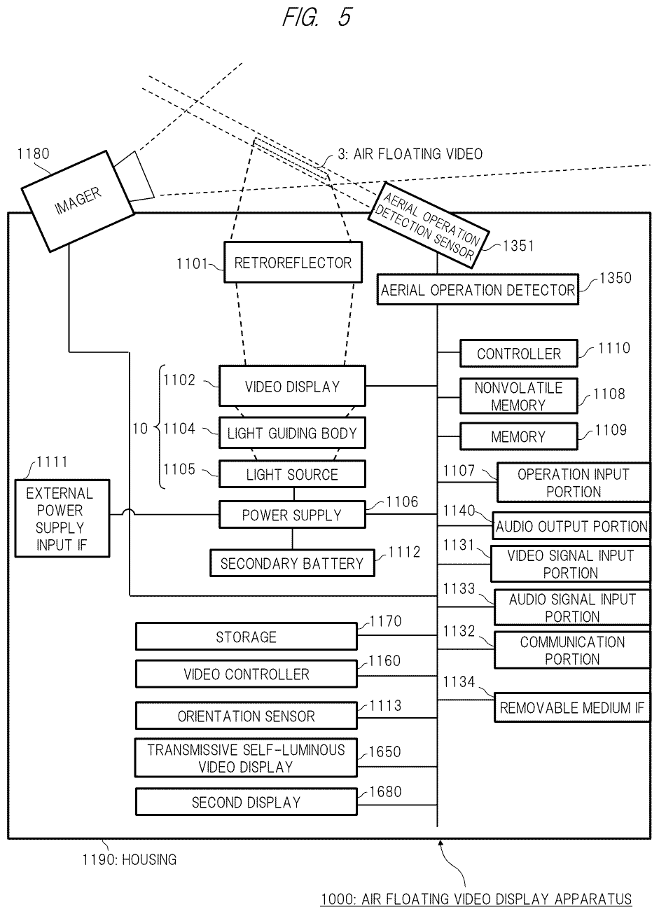

Next, a block diagram of an internal configuration of the air floating video display apparatus 1000 will be described. FIG. 5 is a block diagram showing an example of the internal configuration of the air floating video display apparatus 1000.

The air floating video display apparatus 1000 includes a retroreflector portion 1101, a video display 1102, a light guiding body 1104, a light source 1105, a power supply 1106, an external power input interface 1111, an operation input portion 1107, a nonvolatile memory 1108, a memory 1109, a controller 1110, a video signal input portion 1131, an audio signal input portion 1133, a communication portion 1132, an aerial operation detection sensor 1351, an aerial-operation detector 1350, an audio output portion 1140, a video controller 1160, a storage 1170, and an imager 1180, and others. Note that the apparatus may also include a removable medium interface 1134, an orientation sensor 1113, a transmissive self-luminous video display 1650, a second display 1680, a secondary battery 1112 or the like.

Each component of the air floating video display apparatus 1000 is arranged in a housing 1190. Note that the imager 1180 and the aerial operation detection sensor 1351 may be arranged outside the housing 1190.

The retroreflector portion 1101 in FIG. 5 corresponds to the retroreflector 5 in FIG. 2. The retroreflector portion 1101 retroreflects light modulated by the video display 1102. The air floating video 3 is formed by the light emitted to the outside of the air floating video display apparatus 1000 among the reflected light emitted from the retroreflector portion 1101.

The video display 1102 in FIG. 5 corresponds to the liquid crystal display panel 11 in FIG. 2. The light source 1105 of FIG. 5 and the light guiding body 1104 of FIG. 5 have a correspondence relationship included in the light source 13 of FIG. 2.

The video display 1102 is a display that modulates the transmitted light to form the video, in response to an input video signal by control performed by the video controller 1160 described later. The video display 1102 corresponds to the liquid crystal display panel 11 in FIG. 2. As the video display 1102, for example, a transmissive liquid crystal display panel may be used. As the video display 1102, for example, a reflective liquid crystal panel or a DMD (Digital Micromirror Device: registered trademark) panel, a type of which modulates the reflected light, or the like, may be used.

The light source 1105 generates light for the video display 1102 and is a solid-state light source such as an LED light source or laser light source. The power supply 1106 converts an AC current, input from the outside via the external power input interface 1111, into a DC current, and supplies power to the light source 1105. Furthermore, the power supply 1106 supplies necessary DC current to each portion in the air floating video display apparatus 1000. The secondary battery 1112 stores the power supplied by the power supply 1106. The secondary battery 1112 also supplies power to the light source 1105 and other power-requiring components when power is not supplied from the outside via the external power input interface 1111. That is, if the air floating video display apparatus 1000 includes the secondary battery 1112, the user can use the air floating video display apparatus 1000 even when power is not supplied from an external source.

The light guiding body 1104 guides the light formed at the light source 1105 to irradiate the video display 1102. A combination of the light guiding body 1104 and the light source 1105 can be also called a backlight of the video display 1102. The light guiding body 1104 may be mainly made of glass. The light guiding body 1104 may be mainly made of plastic. The light guiding body 1104 may be mainly made of a mirror. Various combinations of the light guiding body 1104 and the light source 1105 are considerable. Specific configuration examples of the combination of the light guiding body 1104 and the light source 1105 will be described in detail later.

The aerial operation detection sensor 1351 is a sensor that detects the operation on the air floating video 3 performed with a user's finger. The aerial operation detection sensor 1351 senses a range overlapping, for example, the entire display range of the air floating video 3. Note that the aerial operation detection sensor 1351 may sense only a range overlapping at least a part of the display range of the air floating video 3.

A specific sensor configuration of the aerial operation detection sensor 1351 is a ranging (distance) sensor using non-visible light such as infrared light, non-visible light laser, ultrasonic waves, or the like. Alternatively, the aerial operation detection sensor 1351 may be configured of a combination of a plurality of such sensors so as to detect coordinates on a two-dimensional plane. Also, the aerial operation detection sensor 1351 may be configured of a LiDAR (Light Detection and Ranging) of a TOF (Time Of Flight) scheme or an imaging sensor.

The aerial operation detection sensor 1351 only needs to be capable of sensing the detection of the touch operation or the like on an object displayed as the air floating video 3, performed with the user's finger. Such sensing can be performed by an existing technique.

The aerial operation detector 1350 acquires a sensing signal from the aerial operation detection sensor 1351, and calculates, for example, the presence or absence of the contact on the object of the air floating video 3 operated with the user's finger or a position of the contact (contact position) of the user's finger on the object, based on the sensing signal. The aerial operation detector 1350 may be made of a circuit such as an FPGA (Field Programmable Gate Array). Also, some functions of the aerial operation detector 1350 may be achieved by, for example, software based on a program for aerial operation detection executed by the controller 1110.

The aerial operation detection sensor 1351 and the aerial operation detector 1350 may be configured to be embedded in the air floating video display apparatus 1000, but may be provided outside the air floating video display apparatus 1000. When being arranged outside the air floating video display apparatus 1000, the aerial operation detection sensor 1351 and the aerial operation detector 1350 may be configured so as to be able to transmit information and signals to the air floating video information display apparatus 1000 through a wired or wireless communication connection path or video signal transmission path.

Alternatively, the aerial operation detection sensor 1351 and the aerial operation detector 1350 may be provided as separated from the air floating video information display apparatus 1000. In this case, it is possible to architect a system in which only the aerial operation detection function can be optionally added to the air floating video information display apparatus 1000 as a main body without the aerial operation detection function. Alternatively, only the aerial operation detection sensor 1351 may be provided as separate while the aerial operation detector 1350 may be embedded in the air floating video information display apparatus 1000. For example, when it is more desirable to freely arrange the aerial operation detection sensor 1351 from the installation position of the air floating video information display apparatus 1000, the structure in which only the aerial operation detection sensor 1351 is as separate is advantageous.

The imager 1180 is a camera having an image sensor, and captures a video (image) of a space in the vicinity of the air floating video 3 and/or user's face, arm, finger and others. A plurality of the imager 1180 may be provided. Alternatively, the imager 1180 may be a camera with a depth sensor. If the plurality of the imagers 1180 or the imager 1180 with the depth sensor is used, the imager 1180 may assist the aerial operation detector 1350 in the detection of the touch operation on the air floating video 3 operated by the user. The imager 1180 may be provided as separated from the air floating video display apparatus 1000. When the imager 1180 is provided as separated from the air floating video display apparatus 1000, the air floating video display apparatus 1000 may be configured to receive an imaging signal to be transmitted through a wired or wireless communication connection path or the like.

For example, if the aerial operation detection sensor 1351 is configured as an object enter area detection sensor that targets a plane (object enter detection plane) including the display surface of the air floating video 3 and that detects whether an object has entered this object enter detection plane, it may be impossible for only the aerial operation detection sensor 1351 to detect information about how far the object (such as the user's finger) not entering the object enter detection plane yet from the object enter detection plane or how near the object to the object enter detection plane.

In this case, by using the object depth calculation information based on the result of the video captured by the plurality of imagers 1180, the object depth information sensed by the depth sensor or the like, a distance between the object enter detection plane and the object can be calculated. Such information and various types of information such as the distance between the object enter detection plane and the object can be used for various display controls on the air floating video 3.

Alternatively, in the present system, the aerial operation detector 1350 may be configured not to use the aerial operation detection sensor 1351 and to detect the touch operation on the air floating video 3 operated by the user, based on the captured video captured by the imager 1180.

Also, an image of the face of the user who is operating the air floating video 3 may be captured by the imager 1180, and the controller 1110 may perform user identification processing. Alternatively, the imager 1180 may be configured to capture an image of a range including the user who is operating the air floating video 3 and surroundings of the user in order to determine whether a different person who is standing around or behind the user who is operating the air floating video 3 takes a peek at the operation of the user on the air floating video 3 or the like.

An operation input portion 1107 is, for example, an operation button, or a signal receiver or an infrared receiver such as a remote controller, and inputs a signal about the user's operation different from the aerial operation (touch operation). The operation input portion 1107 may be used to operate the air floating video display apparatus 1000 by, for example, an administrator instead of the user who performs the touch operation on the air floating video 3.

The video signal input portion 1131 is connected with an external video output apparatus to receive the video data therefrom as its input. To the video signal input portion 1131, various digital video input interfaces are applicable. For example, the video signal input portion 1131 may be made of a video input interface of HDMI (registered trademark) (High-Definition Multimedia Interface) standard, a video input interface of DVI (Digital Visual Interface) standard, or a video input interface of Display Port standard. Alternatively, an analog video input interface such as analog RGB or composite video may be provided. The audio signal input portion 1133 is connected with an external audio output apparatus to receive the audio data therefrom as its input. The audio signal input portion 1133 may be made of, for example, an audio input interface of HDMI standard, an optical digital terminal interface, a coaxial digital terminal interface or the like. In the case of the interface of HDMI standard, the video signal input portion 1131 and the audio signal input portion 1133 may be configured as an interface with a terminal and a cable that are integrated. The audio output portion 1140 can output the audio based on the audio data input to the audio signal input portion 1133. The audio output portion 1140 may be made of a loudspeaker. Also, the audio signal output portion 1140 may output built-in operation sounds and error alert sounds. Alternatively, the audio output portion 1140 may be configured to output a digital signal to an external apparatus, as seen in the Audio Return Channel function defined in the HDMI standard.

The non-volatile memory 1108 stores various types of data for use in the air floating video display apparatus 1000. The data stored in the non-volatile memory 1108 includes, for example, various types of operation data, a display icon, data and layout information of an object to be operated by the user, to be displayed on the air floating video 3. The memory 1109 stores video data and apparatus control data to be displayed as the air floating video 3.

The controller 1110 controls the operation of each portion to be connected. The controller 1110 may perform computing processing based on information acquired from each portion in the air floating video display apparatus 1000, in cooperation with the program stored in the memory 1109.

In addition, the removable medium interface 1134 is an interface that connects a removable recording medium (removable medium). The removable recording medium may be made of a semiconductor element memory such as a solid state drive (SSD), a magnetic recording medium recording device such as a hard disk drive (HDD), an optical recording medium such as an optical disk or the like. The removable medium interface 1134 can read various types of information of various data or the like such as video data, image data, and audio data recorded in the removable recording medium. The video data, image data, and the like recorded in the removable recording medium are output as the air floating video 3 via the video display 1102 and the retroreflector portion 1101.

The storage 1170 is a storage device that records various types of information of various data or the like such as video data, image data, and audio data. The storage 1170 may be made of a magnetic recording medium recording device such as a hard disk drive (HDD) or a semiconductor element memory such as a solid state drive (SSD). The storage 1170 may record, for example, various types of information of various data or the like such as video data, image data, and audio data previously recorded at the time of product shipment. Also, the storage 1170 may record various types of information of various data or the like such as video data, image data, and audio data acquired from an external apparatus, an external server, or the like via the communication portion 1132.

The video data, image data, and the like recorded in the storage 1170 are output as the air floating videos 3 via the video display 1102 and the retroreflector portion 1101. The storage 1170 also records the video data, image data, and the like such as the display icon or the object to be operated by the user that are displayed as the air floating videos 3 are.

The storage 1170 also records the layout information on the display icon, the object or the like to be displayed as the air floating videos 3, the information on various metadata about the object and the like. The audio data recorded in the storage 1170 is output as, for example, audio from the audio output portion 1140.

The video controller 1160 performs various control for the video signal input to the video display 1102. The video controller 1160 may also be referred to as a video processing circuit, and may be made of, for example, hardware such as an ASIC, an FPGA, and a video processor. Note that the video controller 1160 may also be referred to as a video processor or an image processor. The video controller 1160 performs control for, for example, video switching as to which video signal is to be input to the video display 1102 out of the video signals to be stored in the memory 1109 and the video signals (video data) input to the video signal input portion 1131.

Also, the video controller 1160 may perform control to form a composite video as the air floating video 3 by generating a convolution video signal formed by performing convolution on the video signal to be stored in the memory 1109 and the video signal input from the video signal input portion 1131, and then, inputting the convolution video signal to the video display 1102.

Also, the video controller 1160 may perform control for the image processing to the video signal input from the video signal input portion 1131 and the video signal to be stored in the memory 1109. Examples of the image processing are, for example, a scaling processing to expand, shrink, deform the image or the like, a brightness adjustment processing to change a luminance, a contrast adjustment processing to change a contrast curve of the image, a retinex processing to decompose the image into light components and then change a weighting of each component and the like.

Also, the video controller 1160 may perform a special effect video processing or the like for assisting the user's aerial operation (touch operation) on the video signal input to the video display 1102. The special effect video processing is performed based on, for example, the detection result of the user's touch operation detected by the aerial operation detector 1350 or the image captured using the imager 1180 by the user.

The orientation sensor 1113 is a sensor made of a gravity sensor, an acceleration sensor or a combination thereof, and can detect an orientation of the installed air floating video display apparatus 1000. Based on an orientation detection result of the orientation sensor 1113, the controller 1110 may control the operation of each connected portion. For example, when an unfavorable orientation for a use state of the user is detected, the controller 1110 may perform control to stop displaying the video displayed on the video display 1102 and to show an error message to the user. Alternatively, when the orientation sensor 1113 detects change of the orientation of the installed air floating video display apparatus 1000, the controller 1110 may perform control to rotate the direction of the display of the video displayed on the video display 1102.

As explained above, the air floating video display apparatus 1000 has various functions. However, the air floating video display apparatus 1000 does not need to include all of these functions, and may have any configuration as long as it has a function to form the air floating video 3.

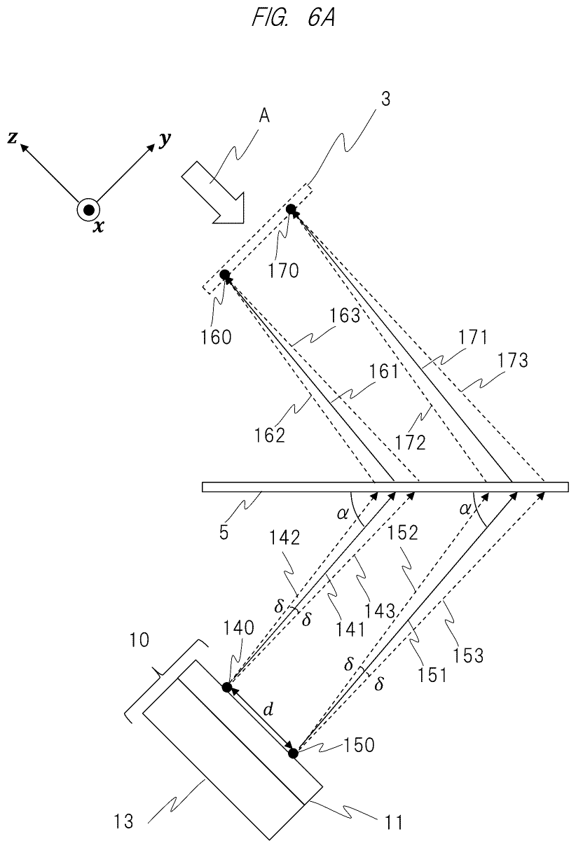

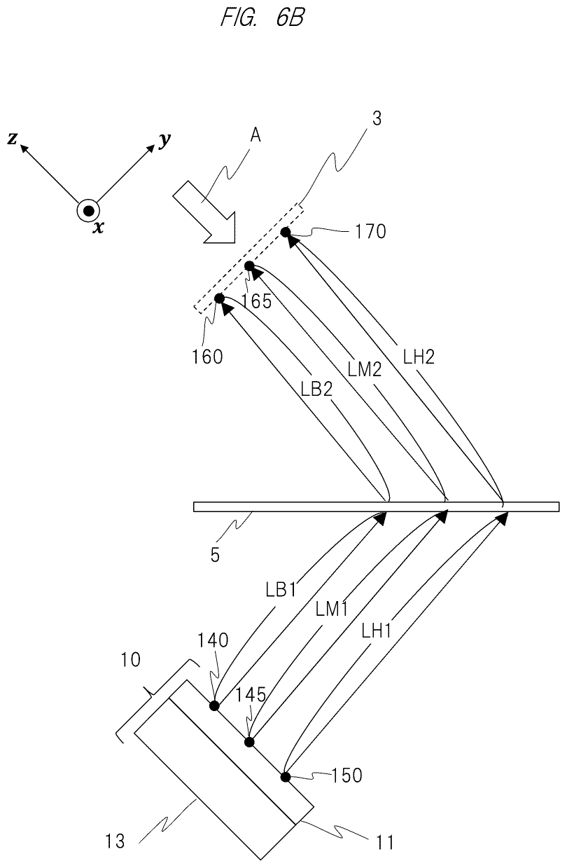

Next, a relationship between a light emission point and an imaging optical distance in the display 10 will be described. FIG. 6A is a diagram showing the imaging optical path in a configuration example of the air floating video display apparatus 1000.

Of the two light emission points separated on the display 10 by an interval “d”, a light emission point with the larger z-coordinate is assumed to be a light emission point 140 while a light emission point with the smaller z-coordinate is assumed to be a light emission point 150. Since the light rays emitted from the light emission points 140 and 150 have the same diffuse property, sub-light rays 152 and 153 that shift by a diffusion angle “±δ” from the principal light ray 151 emitted from the light emission point 150 can be defined as light fluxes corresponding to sub-light rays 142 and 143 that shift by a certain diffusion angle “±δ” from the principal light ray 141 emitted from the light emission point 140.

The principal light rays 141 and 151 are emitted in the direction of incident angle α with respect to the retroreflector 5. A difference between a distance between the incident points of the sub-light rays 142 and 143 on the retroreflector 5 and a distance between the incident points of the sub-light rays 152 and 153 on the retroreflector 5 can be expressed as follows:

$$[ Equation 1 ]$$

$$\frac{d sin α}{tan ( α - δ )} - \frac{d sin α}{tan ( α + δ )} \qquad ( 1 )$$

After entering the retroreflector 5, the principal light rays 141, 151 and the sub-light rays 142, 143, 152, 153 are reflected to become principal light rays 161, 171 and sub-light rays 162, 163, 172, 173, respectively. The principal light ray 161 and the sub-light rays 162 and 163 become convergent light rays, and aerially form an optical real image at an imaging point 160. Similarly, the principal light rays 171 and the sub-light rays 172 and 173 become convergent light rays, and aerially form a real optical image at an imaging point 170. These imaging points gather to form the air floating video 3. Here, a region made of the principal light ray 171, the sub-light ray 172, and the sub-light ray 173 entering the imaging point 170 is larger than a region made of the principal light ray 161, the sub-light ray 162, and the sub-light ray 163 entering the imaging point 160, and therefore, the imaging point 170 is more susceptible to aberration than the imaging point 160. This means that the resolution performance of the imaging point 160 is higher than that of the imaging point 170 when being observed from the direction of arrow A.

In other words, note that it can be said that the resolution performance of each imaging point in the optical system of the air floating video display apparatus 1000 of the present embodiment varies depending on the optical path length of the principal light ray of the imaging optical path from the light emission point of the display 10 to the imaging point forming the air floating video 3. For example, FIG. 6B shows, in addition to the imaging point 160 and the imaging point 170, an imaging point 165 that is an intermediate point therebetween and located at the center of the screen of the air floating video 3. Also, FIG. 6B shows, in addition to the light emission point 140 and the light emission point 150 of the display 10, a light emission point 145 that is an intermediate point therebetween and located at the center of the screen of the display 10. The light flux that reaches the imaging point 165 is emitted from the light emission point 145. Therefore, as shown in FIG. 6B, the optical path length of the principal light ray emitted from the light emission point 140 and reaching the imaging point 160 is expressed as “LB1+LB2”. The optical path length of the principal light ray emitted from emission point 145 and reaching the imaging point 165 is expressed as “LM1+LM2”. The optical path length of the principal light ray emitted from the light emission point 150 and reaching the imaging point 170 is expressed as “LH1+LH2”. As can be seen from FIG. 6B, a relationship “LB1+LB2<LM1+LM2<LH1+LH2” is established. Therefore, the optical path length of the principal light ray emitted from the light emission point 140 and reaching the imaging point 160 is the shortest among these three points, the optical path length of the principal light ray emitted from the light emission point 145 and reaching the imaging point 165 is the second shortest, and the optical path length of the principal light ray emitted from the light emission point 150 and reaching the imaging point 170 is the longest among these three points. Therefore, it can be said that the resolution performances of the imaging point 160, the imaging point 165, and the imaging point 170 are in a decreasing order from the highest to the lowest on the air floating video 3. In other words, the resolution performance at the imaging point 165 is lower than that at the imaging point 160, and the resolution performance at the imaging point 170 is lower than that at the imaging point 165. The relationship among the position of the light emission point, the position of the imaging point, the optical path length of the principal light ray, and the resolution performance in the optical system of the air floating video display apparatus 1000 in the present embodiment is as described above. In the optical system of the air floating video display apparatus 1000 in the present embodiment, the same relationship between the optical path length of the principal light rays and the resolution is established at the light emission point of any position on the display 10 and the imaging point of any position on the air floating video 3.

As described above, in the configuration example using the retroreflector 5 described in FIG. 2, the resolution performance of the air floating video 3 output by the air floating video display apparatus 1000 decreases in a region with a large y-coordinate when being observed from the direction of arrow A. The image processing method according to one embodiment of the present invention aims to correct the ununiformity of videos caused by the difference in the resolution performance depending on the y-coordinate on the air floating video 3.

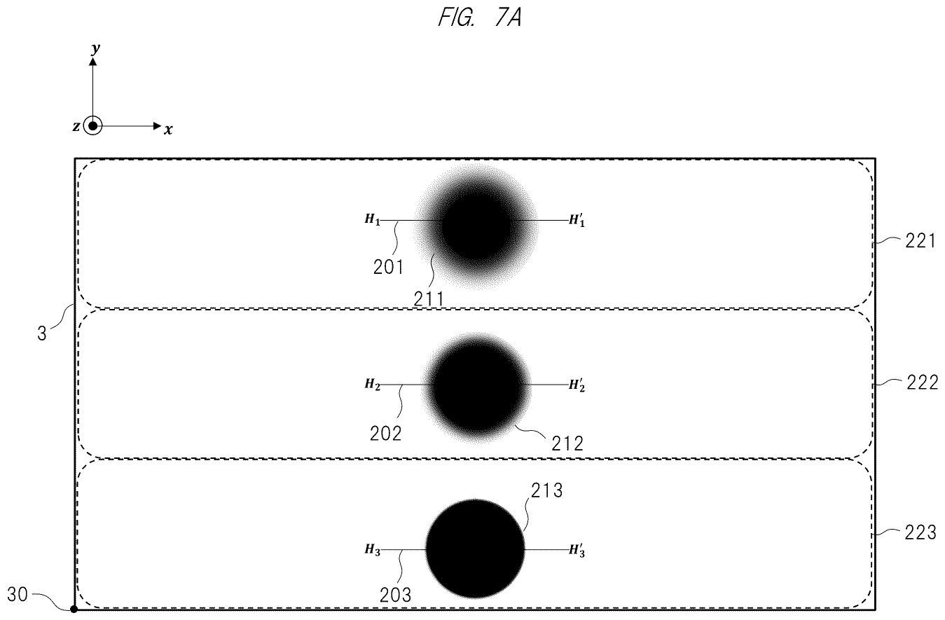

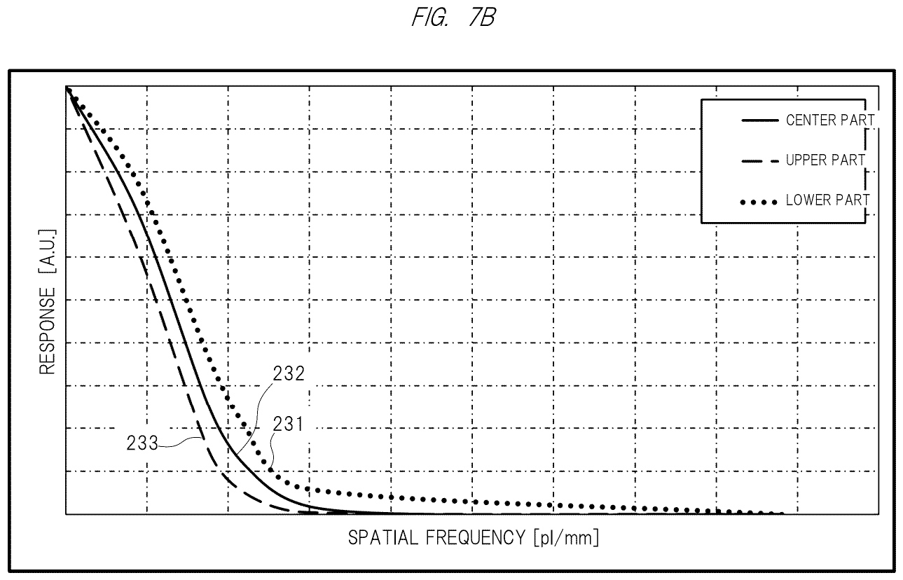

A state of view of the air floating video 3 when being actually observed from the direction of arrow A will be described. FIG. 7A shows the difference in the resolution performance of each region of the air floating video 3 at time of output of a specific pattern. FIG. 7B shows the luminance change corresponding to the x-direction for the display pattern in FIG. 7A.

In the display 10, circular patterns 211, 212, and 213 having the same radius are output to be displayed one by one in each of three regions corresponding to the y-coordinate values obtained when the air floating video 3 is observed from the direction of arrow A. In FIG. 7B, profiles of the luminance changes along lines 201 (H1-H′1), 202 (H2-H′2), and 203 (H3-H′3) that penetrate through the centers of the circular patterns 211, 212, and 213 and are parallel to the x-axis are illustrated as curves 231, 232, and 233, respectively. In the following descriptions, note that three regions 221, 222, and 223 divided depending on the y-coordinate values obtained when the air floating video 3 is observed from the direction of arrow A will be expressed as an upper part, a central part, and a lower part, respectively.

As explained with reference to FIGS. 6A and 6B, in the air floating video 3, the imaging performance of the optical real image displayed in the central part is lower than that in the lower part, and the imaging performance of the optical real image displayed in the upper part is lower than that in the central part. That is, the visual recognition (resolution and sharpness/detail) of the circular pattern 212 is lower than that of the circular pattern 213, and the visual recognition of the circular pattern 211 is lower than that of the circular pattern 212. This influence in FIG. 7A is observed as visual information such as blurring of the optical real image, and this influence in FIG. 7B is observed as qualitative information such as long tail curve of the luminance gradient when viewed in the x-direction.

In FIG. 7B, an example of how the sharpness/detail of the air floating video 3 depends on the optical distance is expressed by MTF (Modulation Transfer Function) as a response depending on a spatial frequency.

A method of measuring the MTF as a sharpness/detail evaluation index for the air floating video 3 is, for example, a square wave chart method for evaluating a transition degree of a square wave pattern (illustrated so that rectangles filled with white and black are arranged at a certain interval). This is a method taking a value as the MTF, the value being calculated by dividing an amplitude of a periodic measured-luminance change of the (the amplitude is a difference between the maximum measured luminance value and the minimum measured luminance value) observed from the direction of arrow A in FIG. 2 by an amplitude of a periodic luminance change (the amplitude is a difference between the maximum input luminance value and the minimum input luminance value) caused by the input square wave. The method of measuring the MTF is not limited to the square wave chart method described above, and may include an edge method using the Fourier transform or the like in addition to this method. The MTF response representing the sharpness/detail does not depend on and is the same in the measurement method. Hereafter, the measured MTF value is expressed as MTF, MTF response, response, or the like. However, the measurement method is not limited to the square wave chart method described above. In this case, the interval in real space of the illustrated square wave pattern is defined as the spatial frequency. The spatial frequency is an index representing the resolution performance of the illustrated pattern, given in a unit of “pl/mm” or the like. Note that the units used for spatial frequency are “LP/mm”, “cycles/mm”, “line pairs/mm”, “lines/mm” and the like, all of which represent the same index.

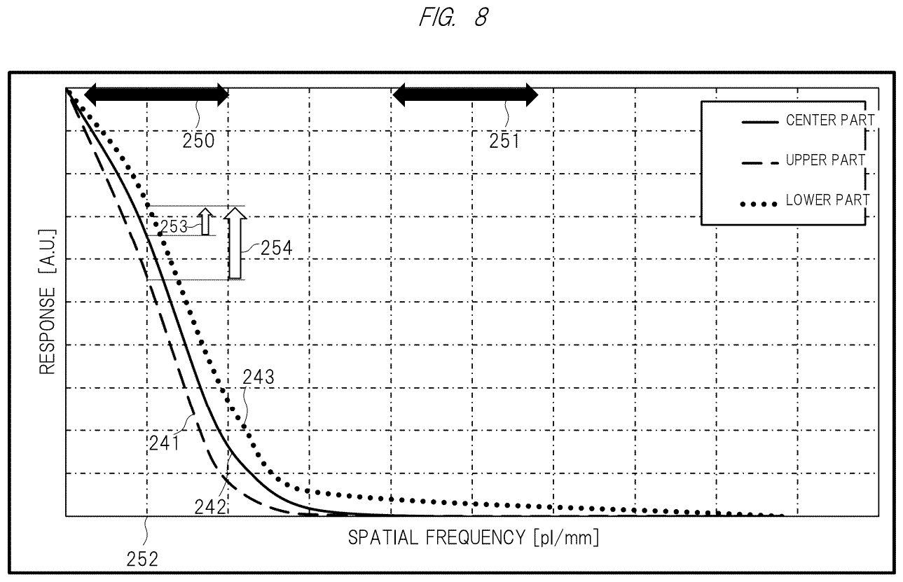

In FIG. 8, numerals 241, 242, and 243 indicate examples of the sharpness/detail property measured at the upper part, the central part, and the lower part of the air floating video 3 displayed by the air floating video display apparatus 1000, respectively, and indicate, in the present embodiment, the curves representing the MTF properties. As explained in FIG. 7B, at the upper part where the imaging performance is low, the MTF response is also lowered because the maximum luminance is lowered. Therefore, in all spatial frequency regions, it can be said that the MTF response is higher at the central part than at the upper part and higher at the lower part than at the central part.

Also, as described above, the pixel pitch of the air floating image 3 decreases down to about ⅓ of the pixel pitch of the display 10. Since the pixel pitch corresponds to the spatial frequency, the larger the response at a higher spatial frequency is, the higher the resolution performance and the sharpness/detail are. For example, the response property based on the display 10 in a spatial frequency range 250 is reflected as the response property based on the air floating video display apparatus 1000 in a spatial frequency range 251. That is, the high-resolution pattern display being displayable by the display 10 and corresponding to the spatial frequency range 251 is not suitable for the air floating video 3.

A suitable display pattern of the air floating video 3 and a method of correcting thereof will be described. It is desirable to form a display video within the spatial frequency range 250 in which the air floating video 3 can ensure a sufficient response. The response of the air floating video 3 in a specific spatial frequency 252 is higher at the central part than at the upper part and higher at the lower part than at the central part. When a display video typified in the spatial frequency 252 is output from the display 10, response differences 253 and 254 occur between the lower part and the central part and between the lower part and the upper part, respectively. In order to unify the sharpness/detail over the entire display region of the air floating video 3, a correction processing is performed on the input video signal so as to correct the response difference 253 at the central part and the response difference 254 at the upper part. That is, in the air floating video 3, the sharpness/detail of the entire display region can be corrected to be unified by specifying a correction amount of the correction processing for the input video signal in accordance with the MTF response of each region, thereby achieving the suitable video display for the air floating video display apparatus 1000. The correction processing for the input video signal concerned may be performed by a video processing circuit such as the video controller 1160.

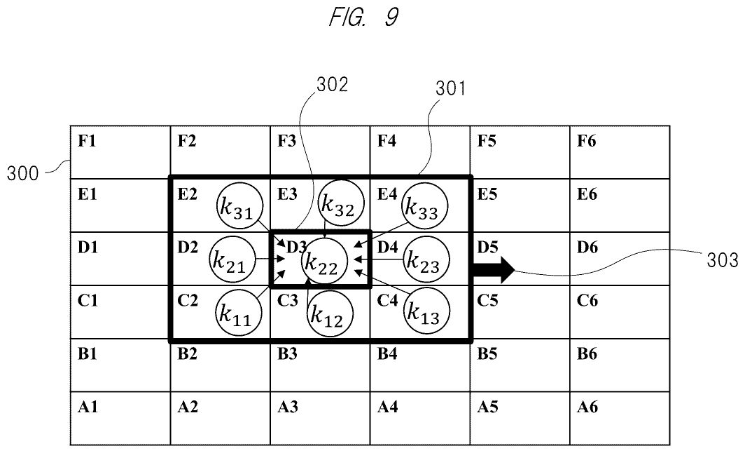

An image processing method using a filter will be described. FIG. 9 shows a filter convolution processing method using some pixels 300 of the liquid crystal display panel 11, and a convolution processing using a 3×3 filter will be described for simplicity.

The liquid crystal display panel 11 outputs light depending on the input value of each pixel, and displays the video by combining the light components over the entire display region. The convolution processing in the image processing is a calculation method that provides the output including the components of the surrounding pixel values in accordance with the components of the filter to be applied. For example, a “3×3” filter 301 with the components with row “I” and column “j” expressed as a coefficient “kᵢⱼ” as shown in FIG. 9 is selected as the filter to be applied. The pixels in a sampled region are assumed to be counted as rows A, B, C, . . . , columns 1, 2, 3, . . . in this order from the bottom left, and their pixel values are assumed to be expressed as a₁, a₂, . . . , b₁, . . . , c₁, . . . . FIG. 9 shows an imaginary convolution processing operation in a case of application of this filter 301 to a pixel D3 (denoted by a numeral 302) in the row D on the column 3. The actually-performed calculation where a newly-obtained pixel value of the pixel D3 is assumed to be d′₃ can be expressed as follows:

$$[ Equation 2 ]$$

$${d}_{3}^{′} = {k}_{11} \times {c}_{2} + {k}_{13} \times {c}_{3} + {k}_{13} \times {c}_{4} + {k}_{21} \times {d}_{2} + {k}_{22} \times {d}_{3} + {k}_{23} \times {d}_{4} + {k}_{31} \times {e}_{2} + {k}_{32} \times {e}_{3} + {k}_{33} \times {e}_{4} \qquad ( 2 )$$

By applying this calculation to, for example, each pixel in order from the lower left as indicated by an arrow 303, the filter effect can be applied to pixel values on the entire surface, and an image with the effect obtained by the image processing can be output. The filter type and its effect vary depending on how to select the coefficient kᵢⱼ. By a larger filter size, the calculated values can be obtained from a larger region. The filter and the pixel values are described as examples, and the calculation is performed based on the same method described below.

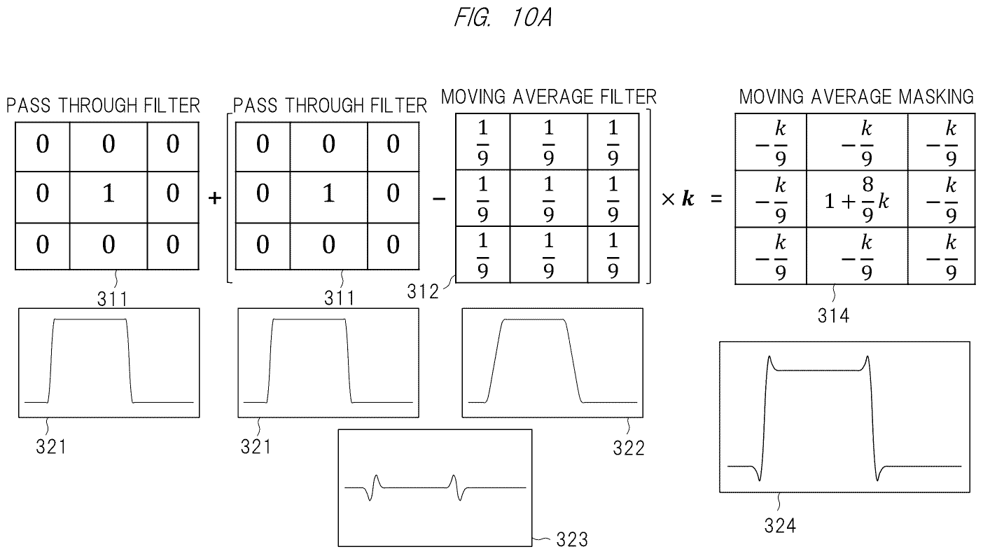

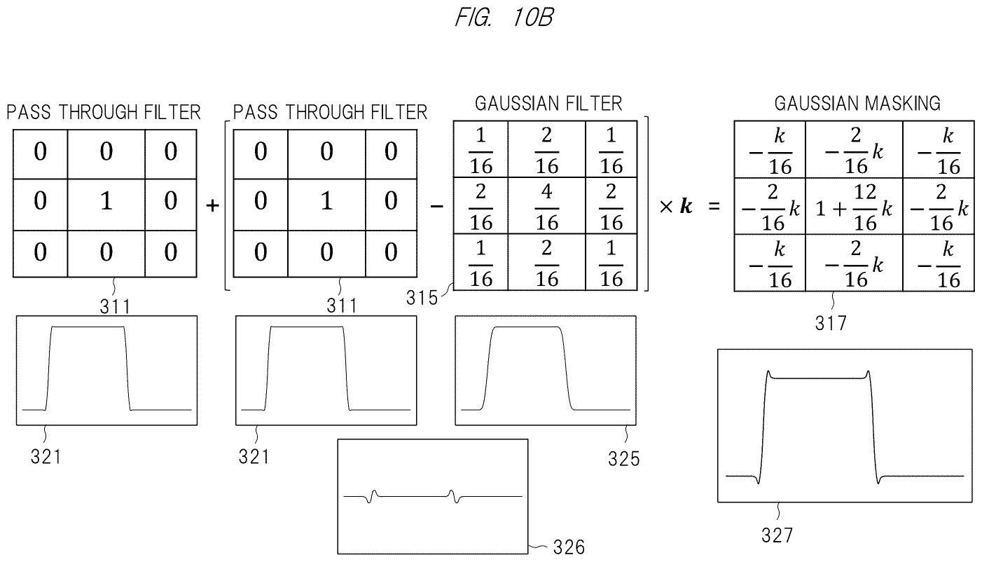

The effect of each filter and how to make them and its concept will be described below. FIG. 10A shows a calculation formula for 3×3-size moving average masking as an example of the filter used for the video sharpness/detail processing. Similarly, FIG. 10B shows a calculation formula for 3×3-size Gaussian masking as an example of the filter used for the video sharpness/detail processing. The video sharpness/detail processing described here also includes a concept such as an edge enhancement (emphasis) processing for enhancing an edge of the image.

The image processing required in FIG. 8 is a sharpness/detail filter that performs the correction while matching the sharpness/detail degree of the upper part or the central part with that of the lower part. The moving average filter and the Gaussian filter functions to remove noises and reduce a pixel value change rate between pixels. The sharpness/detail filter is obtained by a method of adding a difference with a weight “k” between the original image and the blurred image obtained by the moving average filter, the Gaussian filter, or the like to the original image. A processing to convert the original image into an outline-enhanced image by using the difference from the blurred image obtained by the filter processing is called unsharp masking. Based on this, the sharpness/detail filter obtained by the difference from the moving average filter may be called moving average masking, and the sharpness/detail filter obtained by the difference from the Gaussian filter may be called Gaussian masking.

For simplicity, in FIG. 10A, the equation and the effect of the moving average masking using the 3×3 filter will be described. A pass-through filter 311 is a filter that does not change the original image because all elements that weight the surrounding pixel values other than the center are 0. On the other hand, the moving average filter suppresses an amount of change of the applied pixel from the surrounding pixels because the weights of the respective elements are summed up uniformly. In other words, this is a filter that can output the outline-blurred image. Since a result with the application of the pass-through filter 311 is the input image itself, the pixel value change in the input of the square wave signal is illustrated as a pixel value profile 321. In addition, the pixel value change in the use of the moving average filter 312, the pixel value change based on the difference between the pass-through filter 311 and the moving average filter 312, and the pixel value change obtained as the output of the moving average masking 314 obtained as the calculation result are illustrated as pixel value profiles 322, 323, and 324 respectively. From these profiles, it is found that the change gradient of the pixel value profile 322 is suppressed by the moving average filter 312. Therefore, the pixel value profile 323 obtained in the application of the difference between the pass-through filter 311 and the moving average filter 312 generates pulses before and after the pixel value change. The filter that adds the difference with the weight k to the pass-through filter 311 is the moving average masking 314. A convolution result of the pixel value profile 323 as a signal to enhance the outline of the pulse-shaped video signal with the pixel value profile 321 of the original image obtained by the pass-through filter 311 is the effect of the moving average masking 314. In paying attention to the pixel value profile 324, the amount of change or the gradient of the pixel values can be increased by the moving average masking 314.

For simplicity, in FIG. 10B, the equation and the effect of the Gaussian masking using the 3×3 filter will be described. The pass-through filter 311 is a filter that outputs the unchanged-remaining pixel value of the original image as explained in FIG. 10A. On the other hand, the Gaussian filter sums up the weights of the respective elements in accordance with a Gaussian distribution, and therefore, suppresses the amount of change in the applied pixel from the surrounding pixels. In other words, this is a filter that can output the outline-blurred image. Since a result with the application of the pass-through filter 311 is the input image itself, the pixel value change in the input of the square wave signal is illustrated as the pixel value profile 321. In addition, the pixel value change in the use of the Gaussian filter 315, the pixel value change based on the difference between the pass-through filter 311 and the Gaussian filter 315, and the pixel value change obtained as the output of the Gaussian masking 317 obtained as the calculation result are illustrated as pixel value profiles 325, 326, and 327 respectively. From these profiles, it is found that the change gradient of the pixel value profile 325 is suppressed by the Gaussian filter 315. Therefore, the pixel value profile 326 obtained in the application of the difference between the pass-through filter 311 and the Gaussian filter 315 generates pulses before and after the pixel value change. The filter that adds the difference with the weight k to the pass-through filter 311 is the Gaussian masking 317. A convolution result of the pixel value profile 326 as a signal to enhance the outline of the pulse-shaped video signal with the pixel value profile 321 of the original image obtained by the pass-through filter 311 is the effect of the Gaussian masking. In paying attention to the pixel value profile 327, the amount of change or the gradient of the pixel values can be increased by the Gaussian masking 317.

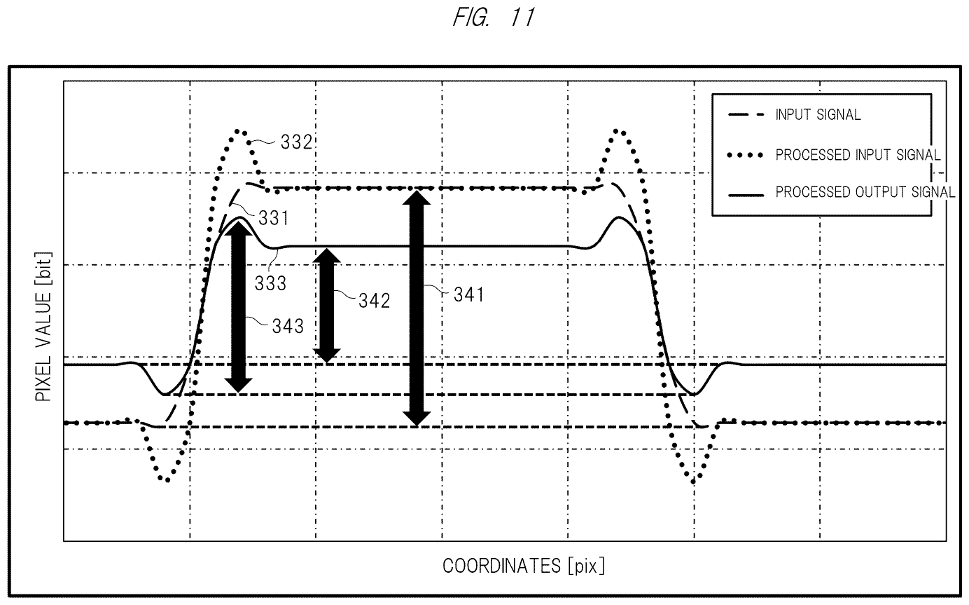

With reference to FIG. 11, the following is explanation for how the viewing state of the output image is changed by the image processing using the sharpness/detail filter such as the moving average masking or the Gaussian masking. FIG. 11 shows the change of the input signal obtained by the sharpness/detail filter and the profile at time of observation of the output as a luminance.

Discuss a luminance profile 331 obtained from an input signal similar to that of the pixel value profile 321 of the square wave signal in FIGS. 10A and 10B. As described above, luminance change of the input signal subjected to the sharpness/detail filter including the moving average masking or the Gaussian masking is enhanced as shown in the luminance profile 332. Since the MTF response is expressed as a ratio of an amplitude of the input signal 341 and an amplitude of the output signal 342, the MTF response value does not change before and after the image processing. However, the user feels that the sharpness/detail is apparently improved by the amplitude 343 including the edge enhanced by the image processing. Although being different from the original definition, in the following MTF response at the image-processed description, the sharpness/detail is set to be the ratio of the amplitude 341 of the input signal and the amplitude 343 including the edge, as an index regarding the sharpness/detail improvement obtained by the video sharpness/detail processing.

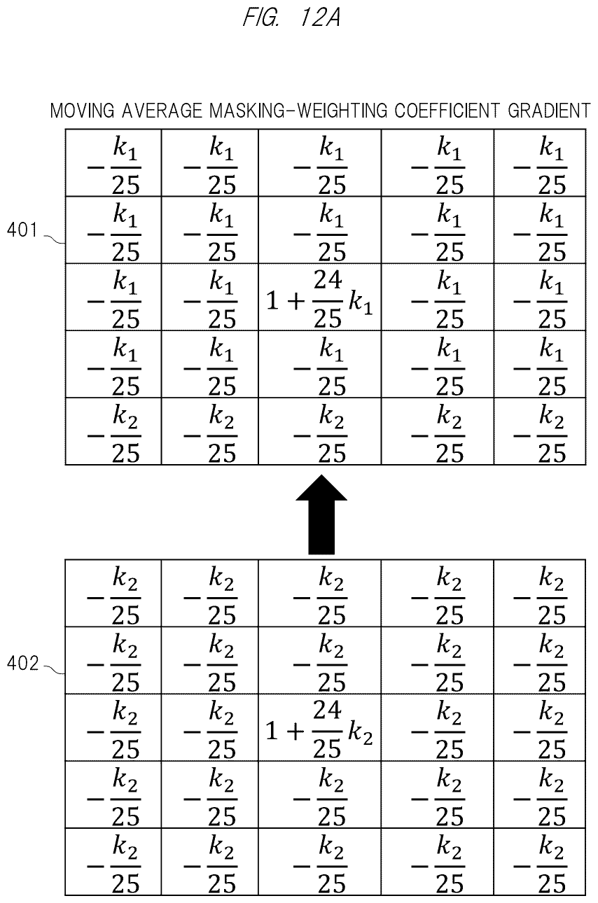

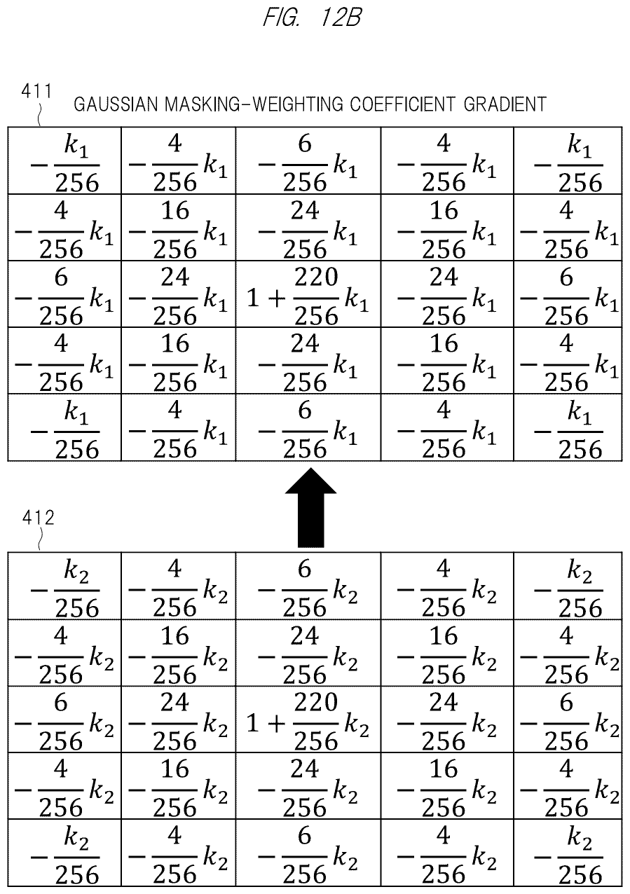

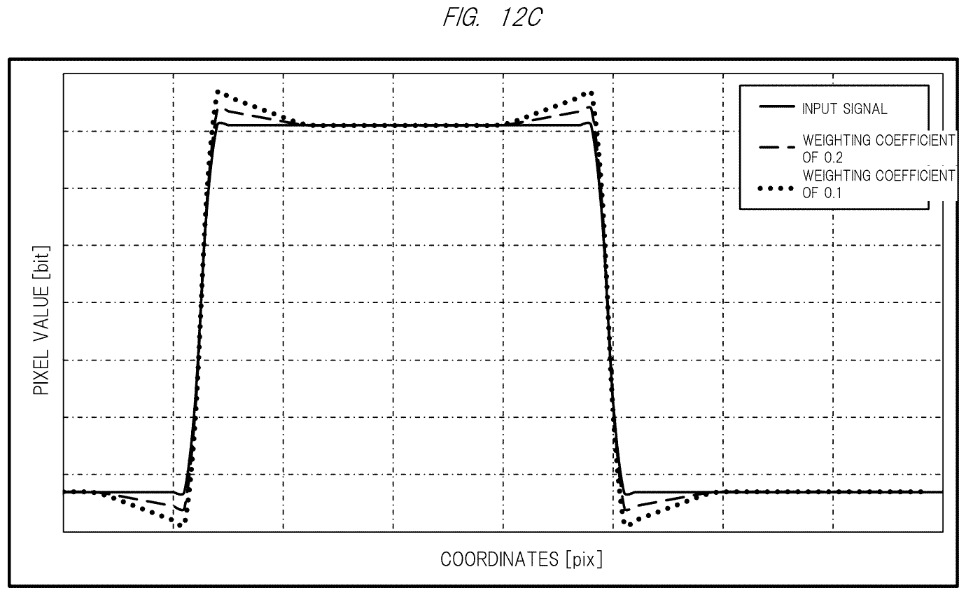

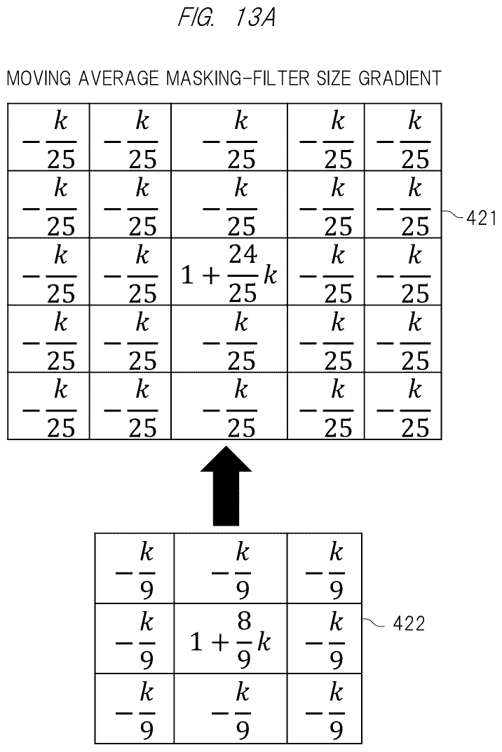

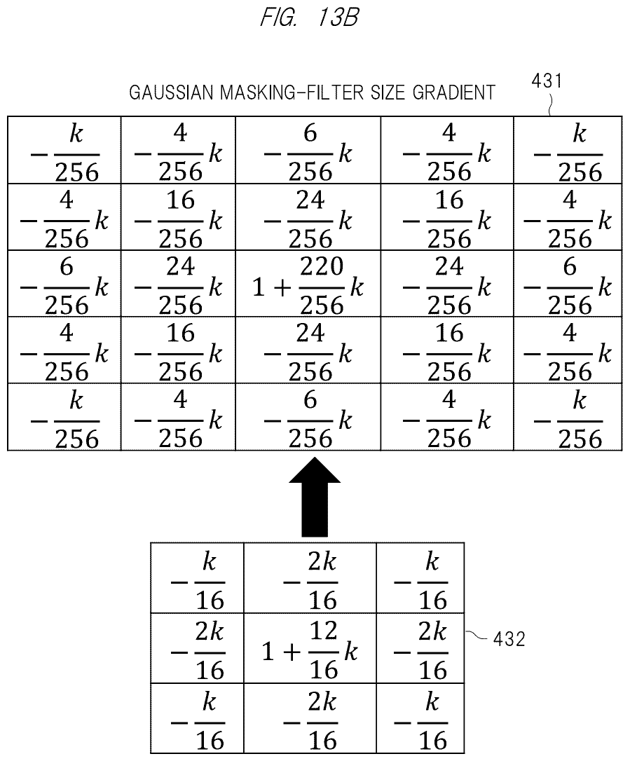

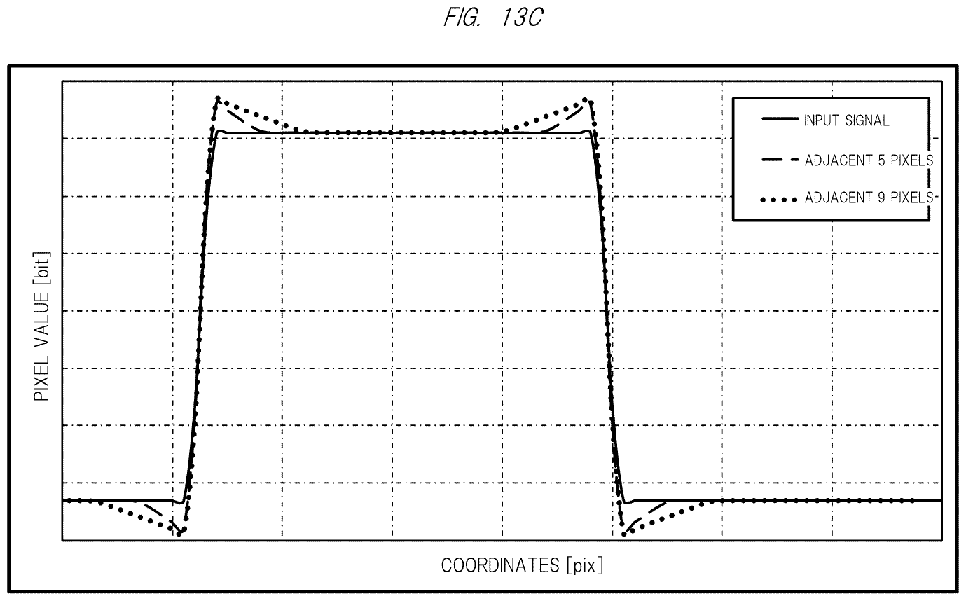

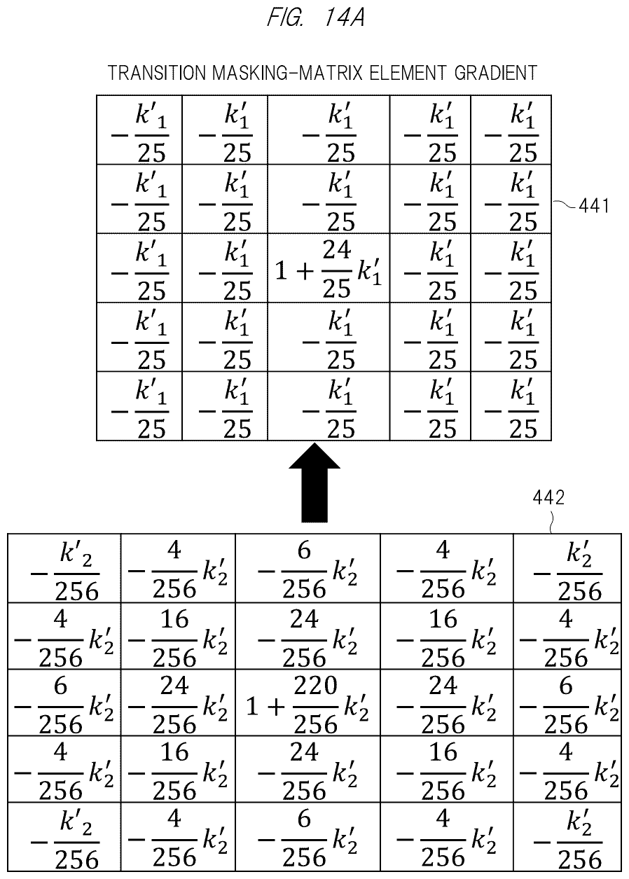

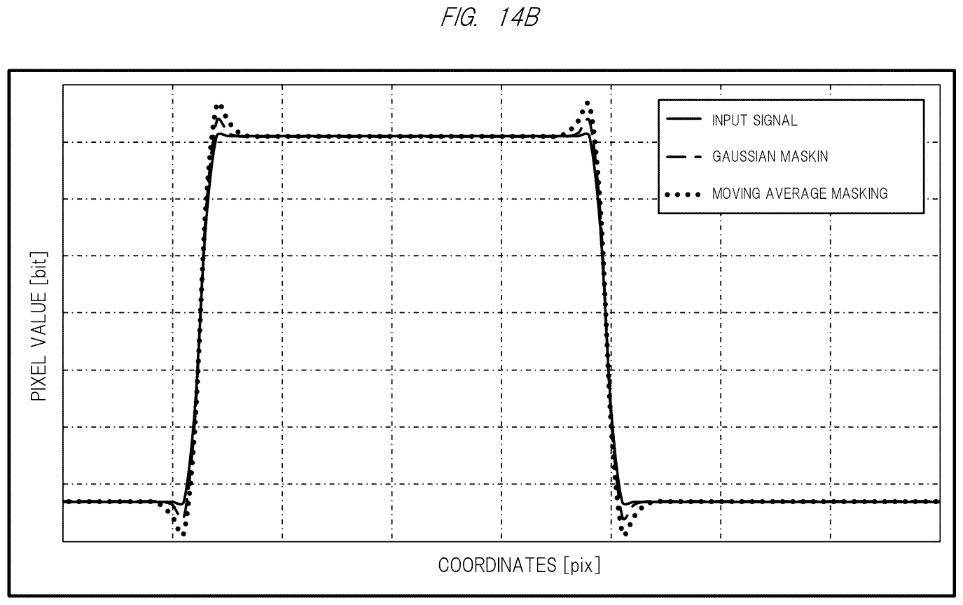

Hereinafter, a method example of changing the applied filter based on the y-coordinate value of each pixel in the air floating video 3 in FIG. 7A in accordance with the weighting coefficient and the filter size determined for the upper part and the lower part will be explained while being roughly divided into three examples. In order to continuously change the sharpness/detail correction amount in accordance with the y-coordinate value, three methods are proposed so that a method (1) changes only the weighting coefficient (weighting coefficient gradient), a method (2) changes only the filter size (filter size gradient), and a method (3) changes the type of the filter to be applied (matrix element gradient). These three methods are described as examples, and the technique is not limited to these methods as long as the method changes the video sharpness/detail processing parameter (filter size, weighting coefficient, and each matrix element) in the filter to the y-coordinate direction. FIGS. 12A, 12B and 12C illustrate the method (1), FIGS. 13A, 13B and 13C illustrate the method (2), and FIGS. 14A and 14B illustrate the method (3) for explanation.

In the image processing according to the present invention, the video sharpness/detail processing for improving the sharpness/detail is performed to a plurality of pixels included in an optional y-coordinate region of the air floating video 3. Of the y-coordinate range to which the video sharpness/detail processing is applied, the maximum value is assumed to be “y₁”, and the minimum value is assumed to be “y₂”. In order to apply the image processing according to the present invention to the entire region of the air floating video 3, it is necessary to set y₁ to the upper end of the air floating video 3 while y₂ to the lower end of the air floating video 3. However, the application range is not limited thereto. When y₁ is set to other portion than the upper end of the air floating video 3 while y₂ is set to other portion than the lower end of the air floating video 3, it is desirable in a case of “y>y₁” that the video sharpness/detail processing parameter at y₁ be applied, and in a case of “y>y₂” that the video sharpness/detail processing parameter at y₂ be applied. However, the present invention is not limited thereto.

The image processing according to the present invention aims at correcting the sharpness/detail on the entire surface of the air floating video 3 to be almost unified by changing the correction amount in accordance with the gradient of the sharpness/detail change from the upper part to the lower part of the air floating video 3 obtained as a property of the air floating video display apparatus 1000. The optional sharpness/detail filter is applied to y=y₁ and y=y₂ on the air floating video 3, and the corrected response is measured at y=y₁ and y=y₂ on the air floating video 3 by the MTF measurement method described above. The sharpness/detail parameter of each filter to be applied is determined so that the corrected responses at y=y₁ and y=y₂ on the air floating video 3 are almost unified. For simplicity, note that the sharpness/detail filter based on the 3×3- or 5×5-size unsharp masking is used as the filters in FIGS. 12A, 12B, 13A, 13B and 14A. However, a different-size sharpness/detail filter is also effective as a setting filter to be applied in the present invention.

With reference to FIGS. 12A, 12B and 12C, examples of the filter setting in accordance with the sharpness/detail properties 241, 242, and 243 of the air floating video 3, the image processing method, and its effect will be explained. FIGS. 12A and 12B show the method of y-directionally changing the weighting coefficient of each element in order to change an enhancement amount of the sharpness/detail for each region of the air floating video 3. FIG. 12A shows an example of the change of the weighting coefficient in the use of the moving average masking, and FIG. 12B shows an example of the change of the weighting coefficient in the use of the Gaussian masking. FIG. 12C shows an example of the square wave output in the weighting coefficient change based on the moving average masking.

When optional filter size and weighting coefficient are determined for the filters 402 and 412 to be applied to y=y₂, the sharpness/detail correction amount improved by the video sharpness/detail processing can be actually measured. At y=y₁, when the weighting coefficient changes while the sharpness/detail correction amount is measured, the weighting coefficient that generates the correction amount almost unified to y=y₂ can be obtained, and the filter applied at this time is set as the filters 401 and 411 to be applied to y=y₂. The weighting coefficient set for the filters 401 and 411 is assumed to be k₁, and the weighting coefficient set for the filters 402 and 412 is assumed to be k₂. In an application range “y₂<y<y₁” of the video sharpness/detail processing, by dividing the difference between k₁ and k₂ by the number of pixels “y₁-y₂” in the application range, the change rate of the weighting coefficient at an optional coordinate y can be obtained as follows:

$$[ Equation 3 ]$$

$$\frac{{k}_{1} - {k}_{2}}{{y}_{1} - {y}_{2}} \qquad ( 3 )$$

Therefore, the weighting coefficient of the filter actually applied to the optional coordinate y is obtained by multiplying this change rate by the number of pixels y-y₂ from the lower end of the application range, and can be set as follows:

$$[ Equation 4 ]$$

$$\frac{{k}_{1} - {k}_{2}}{{y}_{1} - {y}_{2}} ( y - {y}_{2} ) \qquad ( 4 )$$

The video sharpness/detail processing using this parameter can continuously change the weighting coefficient from the weighting coefficient k₁ at y=y₁ to the weighting coefficient k₂ at y=y₂ in the application range y₂<y<y₁. By the above video sharpness/detail processing, the sharpness/detail on the entire surface of the air floating video 3 can be corrected to be almost unified in accordance with the gradient of the sharpness/detail change from the upper part to the lower part of the air floating video 3 obtained as the property of the air floating video display apparatus 1000.

With reference to FIGS. 13A, 13B and 13C, examples of the filter setting in accordance with the sharpness/detail properties 241, 242, and 243 of the air floating video 3 and the image processing method will be explained. FIGS. 13A and 13B show the method of y-directionally changing the filter size in order to change the enhancement amount of the sharpness/detail for each region of the air floating video 3. FIG. 13A shows an example of the change of the filter size in the use of the moving average masking, and FIG. 13B shows an example of the change of the filter size in the use of the Gaussian masking. FIG. 13C shows an example of the square wave output in the filter size change based on the moving average masking.

When optional filter size and weighting coefficient are determined for the filters 422 and 432 to be applied to y=y₂, the sharpness/detail correction amount improved by the video sharpness/detail processing can be actually measured. At y=y₁, when the filter size changes while the sharpness/detail correction amount is measured, the filter size that generates the correction amount almost unified to y=y₂ can be obtained, and the filter applied at this time is set as the filters 421 and 431 to be applied to y=y₂. The filter size set for the filters 421 and 431 is assumed to be “s₁×s₁”, and the filter size set for the filters 422 and 432 is assumed to be “s₂×s₂”. In the application range “y₂<y<y₁” of the video sharpness/detail processing, by dividing the difference between s₁ and s₂ by the number of pixels “y₁-y₂” in the application range, the change rate of the filter size at an optional coordinate y can be obtained as follows:

$$[ Equation 5 ]$$

$$\frac{{s}_{1} - {s}_{2}}{{y}_{1} - {y}_{2}} \qquad ( 5 )$$

Therefore, the filter size of the filter actually applied to the optional coordinate y is obtained by multiplying this change rate by the number of pixels y-y₂ from the lower end of the application range, and can be set as follows:

$$[ Equation 6 ]$$

$$\frac{{s}_{1} - {s}_{2}}{{y}_{1} - {y}_{2}} ( y - {y}_{2} ) \qquad ( 6 )$$

The video sharpness/detail processing using this parameter can continuously change the filter size from the filter size s₁ at y=y₁ to the filter size s₂ at y=y₂ in the application range y₂<y<y₁. By the above video sharpness/detail processing, the sharpness/detail on the entire surface of the air floating video 3 can be corrected to be almost unified in accordance with the gradient of the sharpness/detail change from the upper part to the lower part of the air floating video 3 obtained as the property of the air floating video display apparatus 1000.

With reference to FIGS. 14A and 14B, examples of the filter setting in accordance with the sharpness/detail properties 241, 242, and 243 of the air floating video 3 and the image processing method will be explained. FIG. 14A shows the method of y-directionally changing the filter type (each matrix element) to be applied in order to change the enhancement amount of the sharpness/detail for each region of the air floating video 3. FIG. 14A shows an example of the change of each matrix element in the use of the moving average masking and the Gaussian masking. FIG. 14B shows an example of the square wave output based on the moving average masking and the Gaussian masking.

When optional filter size and filter type (each matrix element) are determined for the filter 442 to be applied to y=y₂, the sharpness/detail correction amount improved by the video sharpness/detail processing can be actually measured. At y=y₁, when the weighting coefficient of the masking using the filter type different from the filter 442 changes while the sharpness/detail correction amount is measured, the filter size that generates the correction amount almost unified to y=y₂ can be obtained, and the filter applied at this time is set as the filter 441 to be applied to y=y₂. The i-th row j-th column matrix element set for the filter 441 is assumed to be “t₁ (i, j)”, and the i-th row j-th column matrix element set for the filter 442 is assumed to be “t₂ (i, j)”. In the application range “y₂<y<y₁” of the video sharpness/detail processing, by dividing the difference between t₁ (i, j) and t₂ (i, j) by the number of pixels “y₁-y₂” in the application range, the change rate of the i-th row j-th column matrix element at an optional coordinate y can be obtained as follows:

$$[ Equation 7 ]$$

$$\frac{{t}_{1} ( i , j ) - {t}_{2} ( i , j )}{{y}_{1} - {y}_{2}} \qquad ( 7 )$$

Therefore, the weighting coefficient of the filter actually applied to the optional coordinate y is obtained by multiplying this change rate by the number of pixels y-y₂ from the lower end of the application range, and can be set as follows:

$$[ Equation 8 ]$$

$$\frac{{t}_{1} ( i , j ) - {t}_{2} ( i , j )}{{y}_{1} - {y}_{2}} ( y - {y}_{2} ) \qquad ( 8 )$$

The video sharpness/detail processing using this parameter can continuously change the matrix element from the i-th row t-th column matrix element t₁ (i, j) at y=y₁ to the i-th row t-th column matrix element t₂ (i, j) at y=y₂ in the range y₂<y<y₁. By video sharpness/detail processing, the the above sharpness/detail on the entire surface of the air floating video 3 can be corrected to be almost unified in accordance with the gradient of the sharpness/detail change from the upper part to the lower part of the air floating video 3 obtained as the property of the air floating video display apparatus 1000.

In the technique according to the embodiments, since the high-resolution and high-luminance video information is aerially displayed to be aerially floating, for example, the user can perform operations without concern about contact infection in illness. When the technique according to the present embodiments is applied to the system that is used by a large number of unspecified users, a contactless user interface having the less risk of the contact infection in illness and being available without the concern can be provided. Such a technique contributes to “the third goal: Good Health and Well-being (for all people)” of the Sustainable Development Goals (SDGs) advocated by the United Nations.

Furthermore, in the technique according to the embodiments, since the sharpness/detail of the output video light can be almost unified, a bright and clear (detailed) air floating video can be formed. In the technique according to the embodiments, it is possible to provide a highly available contactless user interface capable of significantly reducing power consumption. Such a technique contributes to “the goal: Industry, and Innovation and Infrastructure” “the eleventh goal: Sustainable Cities and Communities” of the Sustainable Development Goals (SDGs) advocated by the United Nations.

Various embodiments have been concretely described above. However, the present invention is not limited to the foregoing embodiments, and includes various modifications. For example, in the above-described embodiments, the entire system has been explained in detail for supporting understanding of the present invention, and is not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

### EXPLANATION OF REFERENCE CHARACTERS

3 . . . air floating video, 4 . . . input operation, 10 . . . display, 100 . . . transparent member, 5 . . . retroreflector, 11 . . . liquid crystal display panel, 13 . . . light source, 1000 . . . air floating video display apparatus, 1110 . . . controller, 1160 . . . video controller, 1180 . . . imager, 1102 . . . video display, 1350 . . . aerial operation detection portion, and 1351 . . . aerial operation detection sensor

1. An air floating video display apparatus for displaying an air floating video, comprising:
a video input interface;
a video processing circuit processing a video, based on an input video to be input via the video input interface;
a video display displaying a video processed by the video processing circuit; and
a retroreflector reflecting video light emitted from the video display to form the air floating video,
wherein an optical path length of the video light emitted from a display surface of the video display, starting from when the video light is emitted from the display surface of the video display and then is reflected on the retroreflector to when the video light reaches a position of the air floating video, differs depending on a position on the display surface of the video display from which the video light is emitted, and
the video processing circuit performs a different video sharpness/detail processing to a plurality of positions of a video based on the input video so as to correspond to a plurality of positions that are different in the optical path length of the video light.

2. The air floating video display apparatus according to claim 1,
wherein a video display region of the display surface of the video display has a rectangular shape,
the video display and the retroreflector are arranged so that the optical path length of the video light at a position on the display surface of the video display is inclined in a first direction that is a direction along one side of the rectangular shape, and
the video processing circuit makes the video sharpness/detail processing different to be stepwise so that an effect of the video sharpness/detail processing at a position in the video based on the input video is inclined in a direction corresponding to the first direction on the display surface of the video display.

3. The air floating video display apparatus according to claim 1,
wherein a plurality of positions that are different in the optical path length of the video light includes a first position and a second position having a longer optical path length of the video light than the optical path length of the video light at the first position, and
at a position of the video based on the input video, for a video sharpness/detail processing at a position corresponding to the second position, the video processing circuit uses a video sharpness/detail processing stronger having a video sharpness/detail effect than a video sharpness/detail effect of a filter processing at a position corresponding to the first position.

4. The air floating video display apparatus according to claim 1,
wherein the video sharpness/detail processing performed by the video processing circuit is a video sharpness/detail processing using a sharpness/detail filter, and
the different video sharpness/detail processing is a video sharpness/detail processing using a different weighting coefficient of the sharpness/detail filter.

5. The air floating video display apparatus according to claim 4,
wherein the sharpness/detail filter is a sharpness/detail filter based on a moving average filter or a sharpness/detail filter based on a Gaussian filter.

6. The air floating video display apparatus according to claim 1,
wherein the video sharpness/detail processing performed by the video processing circuit is a video sharpness/detail processing using a sharpness/detail filter, and
the different video sharpness/detail processing is a video sharpness/detail processing using a different filter size of the sharpness/detail filter.

7. The air floating video display apparatus according to claim 6,
wherein the sharpness/detail filter is a sharpness/detail filter based on a moving average filter or a sharpness/detail filter based on a Gaussian filter.

8. The air floating video display apparatus according to claim 1,
wherein the different video sharpness/detail processing performed by the video processing circuit is a video sharpness/detail processing using a different type of the sharpness/detail filter.

9. The air floating video display apparatus according to claim 1,
wherein the video sharpness/detail processing performed by the video processing circuit is a video sharpness/detail processing using a sharpness/detail filter, and
the different video sharpness/detail processing is a video sharpness/detail processing using a type of the sharpness/detail filter different between a sharpness/detail filter based on a moving average filter and a sharpness/detail filter based on a Gaussian filter.
